(19) United States
(12) Patent Application Publication
(10) Pub. No.: US 2002/0188946 A1
(43) Pub. Date: Dec. 12, 2002

(54) Method and system for interactive programming guide background selection

(76) Inventor: Brian Kohne, San Jose, CA (US)

Correspondence Address: John P. Ward, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/090,206

(22) Filed: Mar. 1, 2002

Related U.S. Application Data
(63) Continuation-in-part of application No. 10/008,229, filed on Nov. 30, 2001.
(60) Provisional application No. 60/273,101, filed on Mar. 2, 2001.

(51) Int. Cl. G06F 3/00; H04N 5/445; G06F 13/00

(52) U.S. Cl. 725/44; 725/39; 725/61

(57) ABSTRACT

Input is received that identifies a broadcasted program. Content is selected, based on the input, to be displayed in a background area of an interactive programming guide.

### RELATED APPLICATIONS

The present application claims priority to the provisional filed application entitled Dynamic, Context-Related Generation and Modification of IPG Backgrounds, filed on Mar. 2, 2001, Ser. No. 60/273,101, which is also incorporated herein by reference. The present application is related to the applications titled METHOD AND SYSTEM FOR CONTENT-BASED BROADCASTED PROGRAM SELECTION, filed on Nov. 30, 2001, Ser. No. 10/008,229; and METHOD AND SYSTEM FOR ADVERTISING BASED ON THE CONTENT OF SELECTED CHANNELS OR BROADCASTED PROGRAMS, filed on Feb. 27, 2002, Ser. No.______.

### FIELD OF THE INVENTION

The invention relates to the field of television. More specifically, the invention relates to the selection of backgrounds displayed with interactive programming guides.

### BACKGROUND OF THE INVENTION

Interactive programming guides (“IPGs”) display information about broadcasted programs on a device such a television set. This information may include the titles of programs which are currently being broadcasted on various channels to which the viewer may tune his television set, as well the titles of programs which will be broadcast on these channels at some future time along with the times during which these programs will be broadcasted. The format in which this information is displayed may vary. The information may be displayed as a list, for example, or contain an audiovisual preview of a selected program's content.

An IPG may also include a background area. The background area includes that area of the IPG that is not used by the IPG to convey information about broadcasted programs. Various patterns, shapes, and colors may be displayed in the background area without interfering with the display of information about broadcasted programs. The background area may appear to be behind or overlapped by the information about broadcasted programs. The content of the background area may be fixed, or it may be variable. The content of the background area may be selectable. However, the content of the background area of those IPGs having a background area has been independent of an IPG user's interaction with the information about broadcasted programs.

### SUMMARY OF THE INVENTION

Input is received that identifies a broadcasted program. Content is selected, based on the input, to be displayed in a background area of an interactive programming guide.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates a flow diagram for selecting content to be displayed in the background area of an interactive programming guide, according to one embodiment;

FIGS. 2A and 2B illustrate flow diagrams for adding a category to a set of categories of content of broadcasted programs, according to one embodiment;

FIGS. 3A and 3B illustrate flow diagrams for removing a category from a set of categories of content of broadcasted programs, according to one embodiment;

FIG. 4 illustrates a flow diagram for selecting an advertisement based on a set of categories of content of broadcasted programs, according to one embodiment;

FIG. 5 illustrates a flow diagram for verifying the adding of a category to a set of categories of content of broadcasted programs, according to one embodiment; and

FIG. 6 illustrates a system for electing content to be displayed in the background area of an interactive programming guide, according to one embodiment.

### DETAILED DESCRIPTION

While the description below refers to categories of content of broadcasted programs, it is clear that the description applies equivalently to categories of content of channels where the general content of those channels is determinable (e.g., channels carrying broadcasted programs dealing largely with news, sports, entertainment, science, business, law, music, movies, etc.).

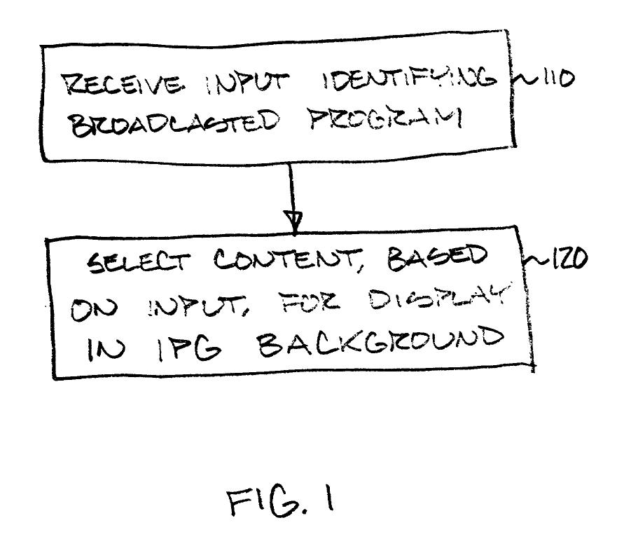

FIG. 1 illustrates a flow diagram for selecting content to be displayed in the background area of an interactive programming guide, according to one embodiment. In processing block 110, input identifying a broadcasted program is received. For example, input identifying a televised football game may be received. In processing block 120, content is selected, based on the input, to be displayed in a background area of an interactive programming guide. For example, an image displaying a football or a team logo, predetermined to be associated with football games, may be selected upon the receipt of input identifying a televised football game. The selected image may be displayed in the background area of the interactive programming guide (e.g., in the area surrounding a list of currently scheduled broadcasted programs. The image may be tiled over the background area or centered. The image may be expanded or reduced to cover the background area or viewing screen area.

In one embodiment, the broadcasted program is selected from a set of broadcasted programs displayed in the interactive programming guide. For example, an interactive programming guide may display a list of titles of broadcasted programs in a matrix with columns corresponding to hours of the day during which each program is broadcasted and rows corresponding to television channels on which each program is broadcasted. A detailed description of each broadcasted program may be displayed with the title of that program. Because, for example, there may be more columns or rows than can be visibly displayed inside the area of the interactive programming guide devoted to the matrix, the columns or rows displayed may scroll in some direction (perhaps automatically), causing some rows or columns which have appeared for the longest duration to vanish from one side of the area while new columns or rows appear on the opposite side of the area. The broadcasted program identified by the input may be selected from among the broadcasted programs currently visible inside the area. The broadcasted program identified by the input could be selected from among those broadcasted programs that are currently being broadcasted on some channel currently displayed inside the area. In an alternative embodiment, the broadcasted program identified by the input may be selected from a set of broadcasted programs which are not displayed in the interactive programming guide at all. For example, the broadcasted program may be randomly chosen from an invisible set of broadcasted programs.

In one embodiment, the broadcasted program is selected by a user of the interactive programming guide. Selection need not involve an actual tuning of a television or other channel selector to the selected broadcasted program. A user could select the broadcasted program by moving a pointing device displayed with the interactive programming guide (e.g., with controls on a television remote control, with a mouse or trackball connected to the viewing system, etc.) over the title of the broadcasted program or within a visibly bounded area in which the title is displayed. While the broadcasted program may then be said to be selected or to have “focus,” the viewing screen would remain displaying the interactive programming guide throughout the selection. The user could select the broadcasted program by manipulating controls that cause the list of broadcasted programs to scroll in some direction. The broadcasted program may be selected from the programs currently being broadcasted whose titles are currently visible in the interactive programming guide. Because the user can control which titles are currently visible, the user has some measure of control over the selection. The selection could also be made by touching the screen in a visibly bounded area in which a title is displayed, or through speech recognition.

In one embodiment, the content to be displayed in the background area includes an image from the broadcasted program. For example, the reception of input identifying a television program could cause the generation of a “snapshot” image comprising a single frame of that program (or a section thereof). The image may then be displayed in the background area of the interactive programming guide. Such an image may be generated at the time that the input identifying the broadcasted program is received (e.g., a current scene from a basketball game), or may be an image recalled from a set of images predetermined to be representative of that broadcasted program (e.g., a particularly dramatic or visually stimulating scene of a televised movie).

In one embodiment, the content includes information about a subject associated with the first broadcasted program. For example, if the broadcasted program is a sports program, then subjects associated with that program may include the score of the game or the statistics of players participating in the game. The subject is predetermined to be associated with the broadcasted program. Associations may be maintained in a database or other data structure. The content may therefore include information about these subjects, such as a current score of the game, or a number of personal fouls committed for a player in the game. Such information may be transmitted with the broadcasted program from the origin of the broadcasted program in real time, or may be added after original transmission by a party other than the original broadcaster or recorder.

In one embodiment, the content is selected based on a category of the broadcasted program. For example, instead of selecting content based on a particular sporting event, content may be selected pertaining to sporting events generally (e.g., the scores of many different sporting events, not only the sporting event which is the broadcasted program. Broadcasted programs may be associated with categories. This association is predetermined. In one embodiment, the content includes information about a subject associated with the category. So, for example, if the broadcasted program is a basketball game predetermined to be associated with the category “sporting event,” then the selected content may pertain (in any manner described above) to another basketball game also predetermined to be associated with that category. The categories with which a broadcasted program is associated may be chosen to be broad or narrow. Categories may be associated with subcategories. A given broadcasted program may be associated with multiple categories.

In one embodiment, new content is selected for display in the background area whenever new input identifying a different broadcasted program is received. In an alternative embodiment, new content is selected after a predetermined interval of time or upon the occurrence of some event. Such an event may be, for example, the scrolling of the matrix or list area of the interactive programming guide, or the modification of parameters used to format the interactive programming guide.

In one embodiment, content selected for display in the background area may be generated by the user of the interactive programming guide. In one embodiment, the user may associate content with one or more broadcasted programs and/or categories of broadcasted programs. In one embodiment, content may be selected from a toolbar or menu bar, such as are well known in many graphical user interfaces, for display in the background area.

In one embodiment, the receiving of input and the selection of content, as described above, occurs only after a determination that a feature providing for these is enabled. In one embodiment, the feature may be enabled or disabled by the user. In one embodiment, the receiving of input and the selection of content occurs only after a determination that content is available for selection (i.e., a determination whether any background images are available and if those which are available are associated with broadcasted programs or categories identified by the input received).

In one embodiment, the broadcasted program identified by the input upon which the content to be displayed in the background area may be selected from a set of categories of content of broadcasted programs. One technique for generating of such a set is presented below.

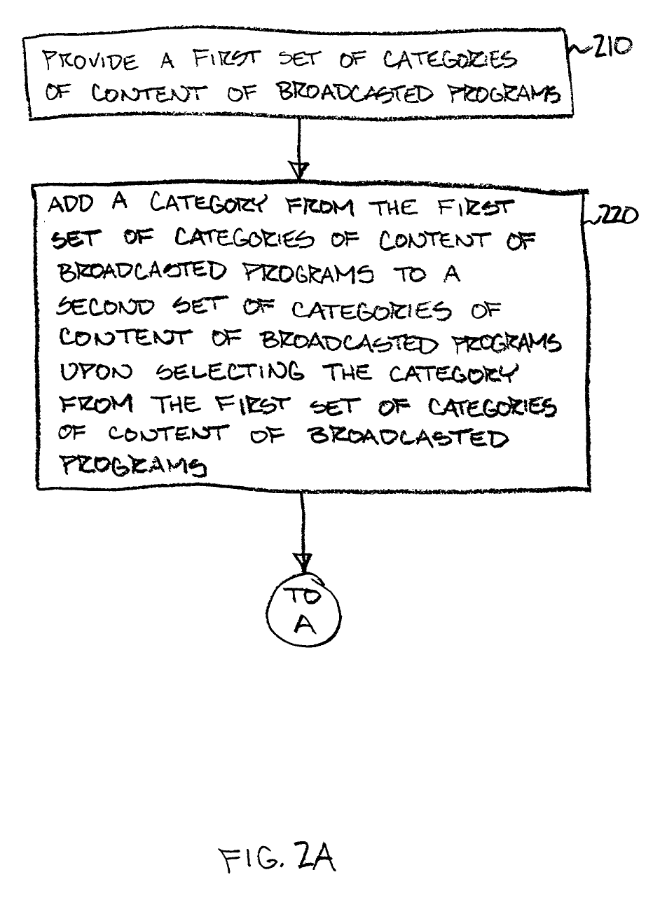

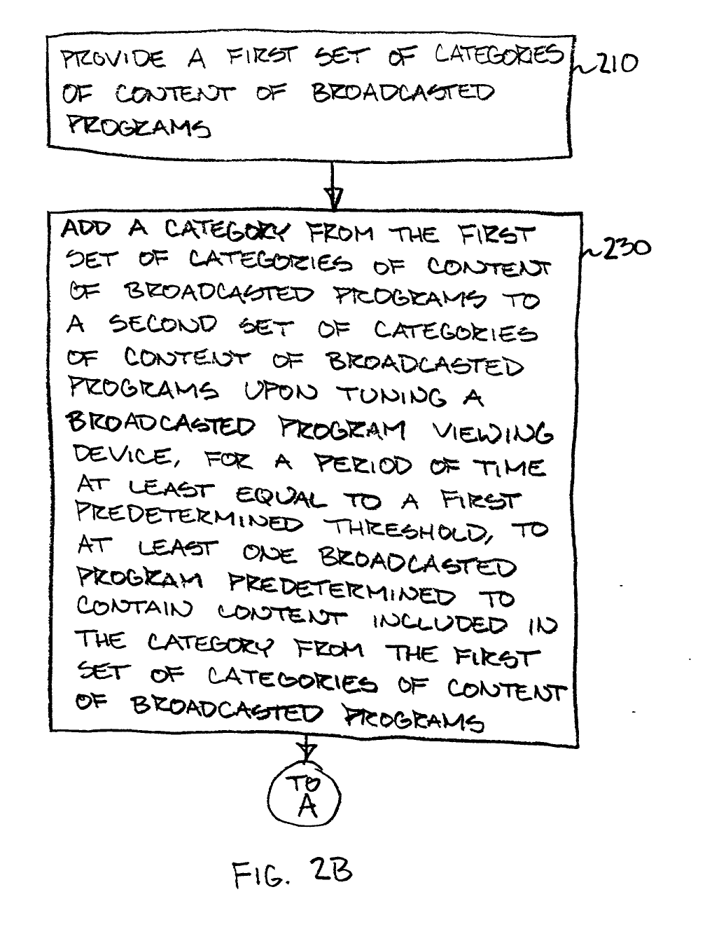

FIG. 2A illustrates a flow diagram for adding a category to a set of categories of content of broadcasted programs, according to one embodiment. In process block 210, a first set of categories of content of broadcasted programs is provided. In one embodiment, the first set of categories of content of broadcasted programs is provided by a media provider. A media provider may be a cable television provider, a satellite television provider, or any other provider of broadcasted programs through a communication medium. The communication medium may be a cable, such as a fiber optic or copper cable, or the communication medium may be a form of unguided medium, such as electromagnetic waves traveling through the air. Whatever the communication medium used, in process block 220, a category from the first set of categories of content of broadcasted programs is added to a second set of categories of content of broadcasted programs upon a selecting of the category from the first set of categories of content of broadcasted programs. Selecting a category of content may be accomplished by using a television remote control to navigate a menu displayed on a television screen.

FIG. 2B illustrates a flow diagram for adding a category to a set of categories of content of broadcasted programs, according to one embodiment. Again, in process block 210, a first set of categories of content of broadcasted programs are provided. But in this embodiment, a category from the first set categories of content of broadcasted programs is added to a second set of categories of content of broadcasted programs upon a tuning of a broadcasted program viewing device, such as a television, for a period of time at least equal to a first predetermined threshold, to at least one broadcasted program predetermined to contain content included in the category from the first set categories of content of broadcasted programs. For example, if a television was tuned to any number of broadcasted programs containing content predetermined to be in the “sports” content category over a combined span of 45 minutes, and if the first predetermined threshold was equal to 30 minutes, then the “sports” category from the first set of categories of content of broadcasted programs would be added to the second set of categories of content of broadcasted programs. In one embodiment, a category may be added based on the number of times that broadcasted programs including content fitting into the category are selected, rather than the length of time that such broadcasted programs are viewed.

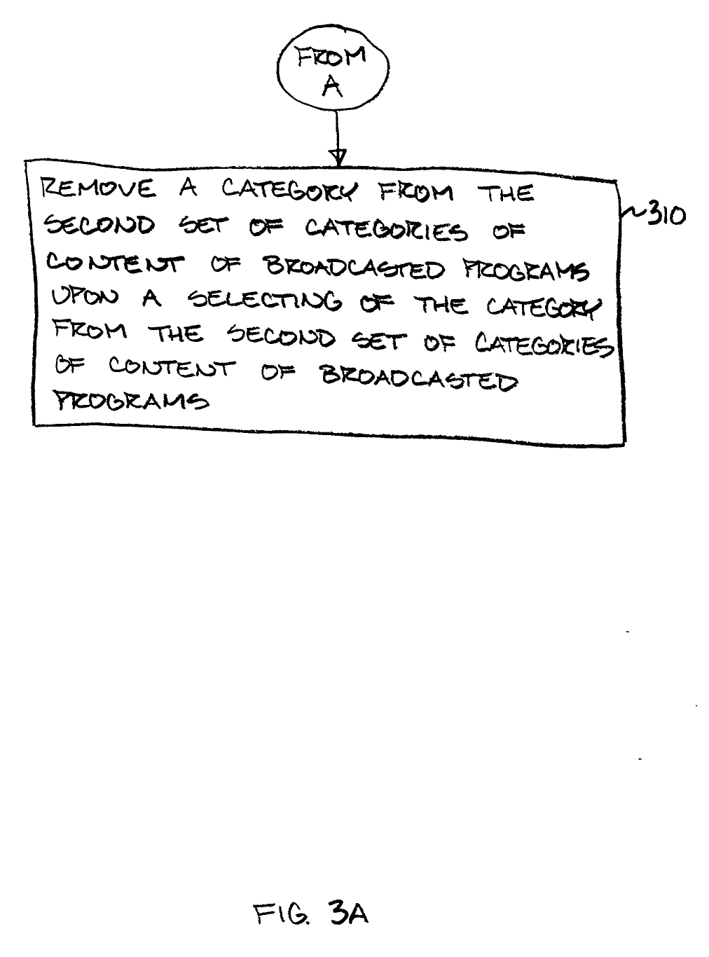

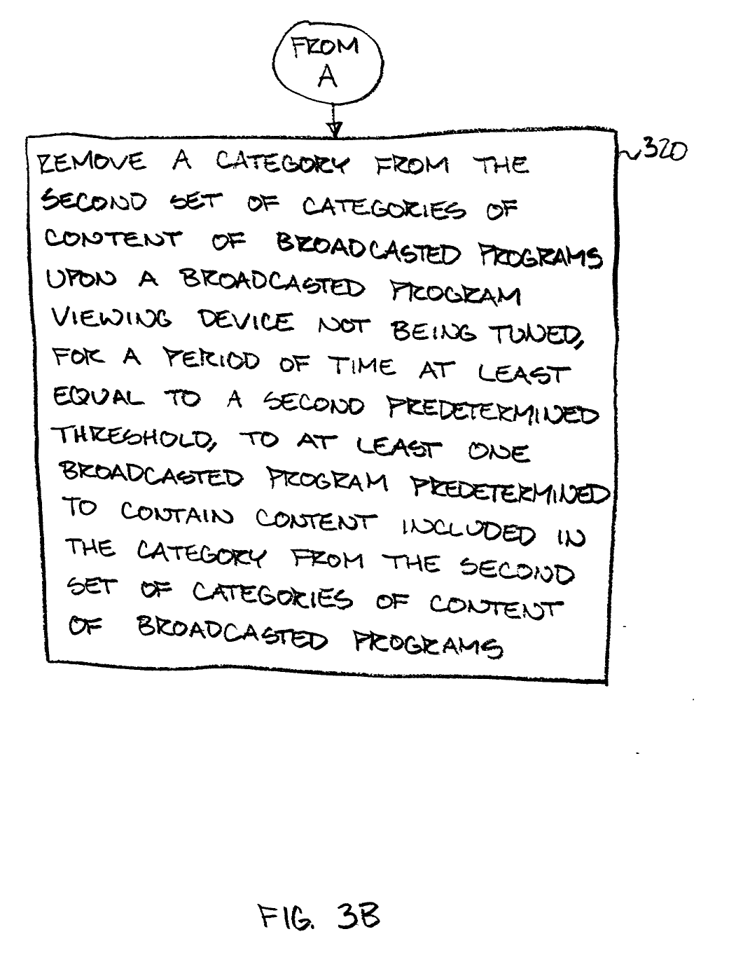

FIG. 3A illustrates a flow diagram for removing a category from a set of categories of content of broadcasted programs, according to one embodiment. In process block 310, a category from the second set of categories of content of broadcasted programs is removed upon a selecting of the category from the second set of categories of content of broadcasted programs. The selection may be accomplished with a remote control and a menu displayed on a television screen as described above.

FIG. 3B illustrates a flow diagram for removing a category from a set of categories of content of broadcasted programs, according to one embodiment. In this embodiment, shown in process block 320, a category is removed from the second set of categories of content of broadcasted programs upon a broadcasted program viewing device not being tuned, for a period of time at least equal to a second predetermined threshold, to at least one broadcasted program predetermined to contain content included in the category from the second set of categories of content of broadcasted programs. For example, if the second set of categories of content of broadcasted programs includes the category of content “news”, and the television is not tuned, over a week or some other predetermined period of time, to broadcasted programs fitting into the “news” content category for at least 30 minutes, and if the second predetermined threshold is 30 minutes, then the category “news” would be removed from the second set of categories of content of broadcasted programs.

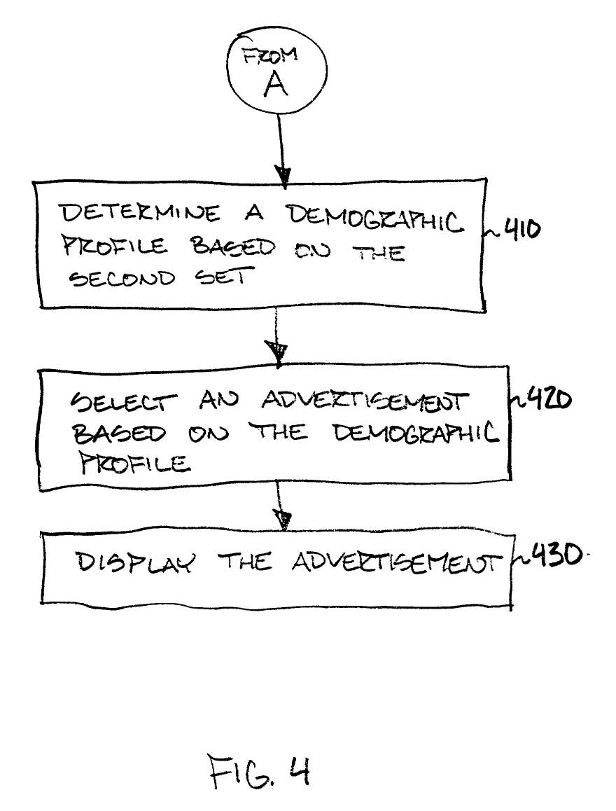

FIG. 4 illustrates a flow diagram for selecting an advertisement based on a set of categories of content of broadcasted programs, according to one embodiment. In processing block 410, a demographic profile is determined based on the second set of categories of content of broadcasted programs. In one embodiment, the categories in the second set may be sorted according to various criteria. In one embodiment, a differentiation of the duration of viewing time for each of the categories in the second set is performed. The categories in the second set may be compared to a number of sets of categories corresponding to different demographic profiles to determine a demographic profile corresponding to a set of categories most closely matching the second set. The demographic profile is a description of various human properties (i.e., gender, age, etc.) typically shared by viewers of broadcasted programs in categories corresponding to the demographic profile. Such human properties may include approximate ranges (e.g., “ages 50 and older”) or precise single values.

For example, a second set of categories including categories “soap opera” and “daytime talk show” might match a demographic profile for women who are homemakers or mothers of young children. A set of categories including categories “action” and “sports” might match a demographic profile for men aged 18-40. A set of categories including a category “late night” might match a demographic for insomniacs. Demographic profiles may include any combination of gender, age, race, income level, region, and/or other human properties. More than one demographic profile may match a set of categories. The duration of viewing time of each category may be used to weight each category, further increasing the accuracy of a resulting demographic profile determination. The demographic profile may be composed of the categories themselves. The demographic profiles and associated categories may be stored in a memory of a device such as a set-top box.

In processing block 420, an advertisement is selected based on the demographic profile. The advertisement selected will be marketing a product or service predetermined to be of special interest to the demographic profile. For example, if the demographic profile is “insomniac,” then an advertisement for specialty mattresses, sleeping medications, personal injury lawyers, etc., may be selected. If the demographic profile is “children under 12” (determined , for example, from a dominance of a “cartoon”category in the set) then an advertisement for breakfast cereal, action figures, traveling circus exhibitions, etc., may be selected.

In processing block 430, the advertisement is displayed. For example, an audiovisual advertisement may be displayed in a region of an IPG. The region may be an unused region of the IPG, a window of the IPG dedicated to the display of advertisements, etc. It is clear that the above examples and others described herein are provided by way of example and are not to be interpreted as limiting.

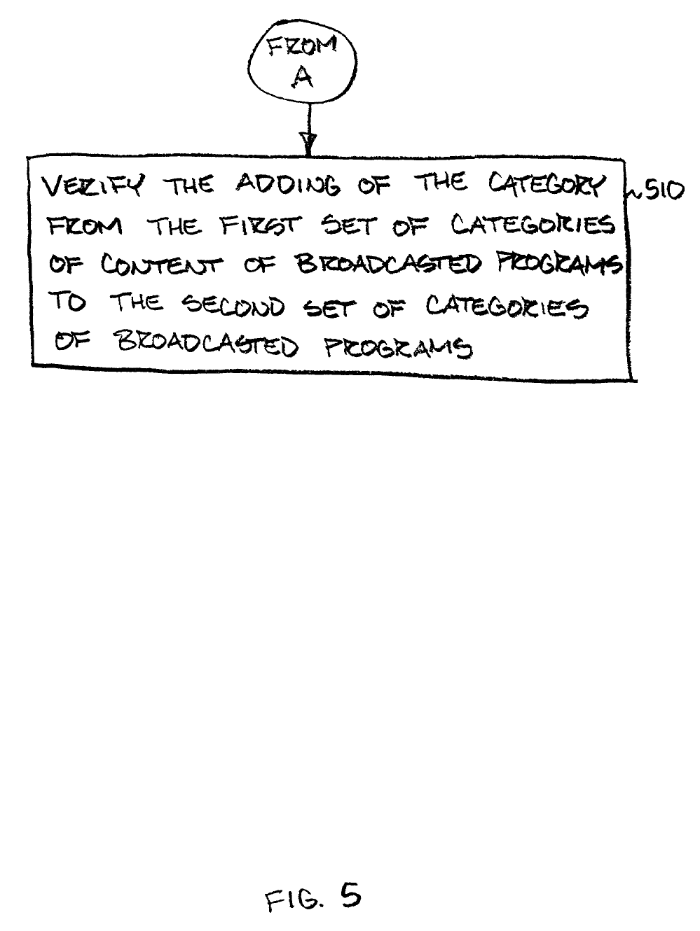

FIG. 5 illustrates a flow diagram for verifying the adding of a category to a set of categories of content of broadcasted programs, according to one embodiment. In process block 510, the adding of the category from the first set of categories of content of broadcasted programs to the second set of categories of broadcasted programs is verified. In one embodiment, a viewer is prompted before a category is added to the second set of categories of broadcasted programs. In one embodiment, a viewer may either allow or disallow the addition of the category to the second set of categories of content of broadcasted programs. This prevents undesirable programs from inadvertently and mistakenly being added to the second set of categories of content of broadcasted programs.

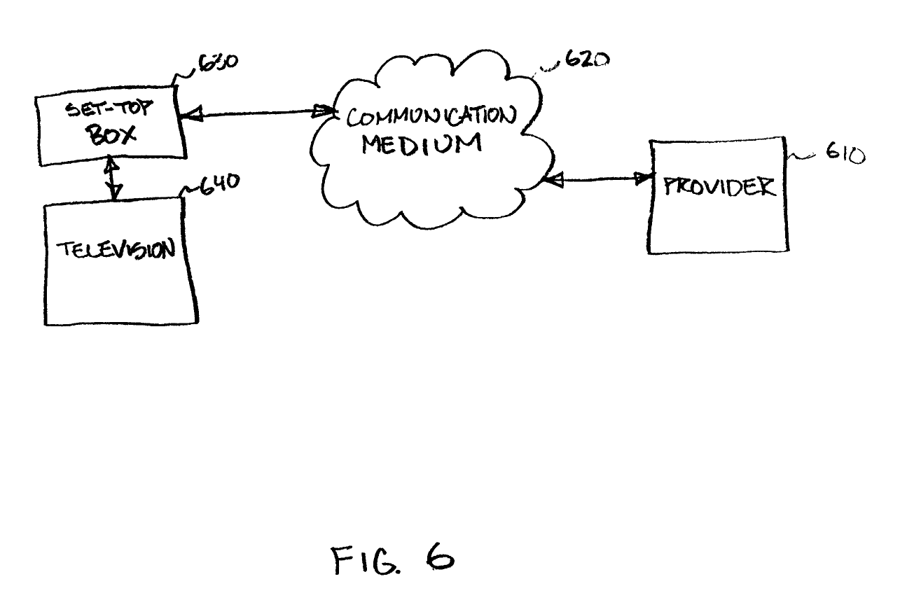

FIG. 6 illustrates a system for selecting content to be displayed in the background area of an interactive programming guide, according to one embodiment. A provider 610 is connected to or otherwise in communication with a communication medium 620. Provider 610 is a media provider, as described above with reference to FIG. 2A. In one embodiment, provider 610 is a computer. Provider 610 may be located at a head end of a broadcasting system. The head end of the broadcasting system is a point from which media is broadcasted through the communication medium to various receivers. Communication medium 620 may be a cable or some form of unguided medium. Communication medium 620 is connected to or otherwise is communication with a set-top box 630. Set-top box 630 may be integrated into a video cassette recorder/player (“VCR”) or digital video disc (“DVD”) player. Set-top box 630 is connected to television 640. Television 640 is to display an interactive programming guide. The interactive programming guide may be generated by provider 610, transmitted through communication medium 620, and received by set-top box 630.

In one embodiment, set-top box 630 is to receive input identifying a broadcasted program and to select content, based on the input, to be displayed in a background area of an interactive programming guide. A first circuit in set-top box 630 may receive input identifying a broadcasted program. A second circuit in set-top box 630 may select content, based on the input, to be displayed in a background area of an interactive programming guide.

In one embodiment, provider 610 is to receive input identifying a broadcasted program. In one embodiment, provider 610 is to select content, based on the input, to be displayed in a background area of an interactive programming guide.

In one embodiment, set-top box 630 is to select an advertisement. A set of advertisements with corresponding demographic profiles may be stored in software and/or circuitry in set-top box 630. The advertisement is based on a demographic profile. The demographic profile is based on a second set of categories of broadcasted programs to which a category from a first set of categories of broadcasted programs was added as described above with reference to FIGS. 2A and 2B. In one embodiment, set-top box 630 is to determine the demographic profile based on the second set. Software and/or circuitry to perform this determination may be stored in set-top box 630. In one embodiment, television 640 is to display the advertisement with an interactive programming guide, as described above with reference to FIG. 4.

In one embodiment, provider 610 is to determine the demographic profile based on the second set. The second set may be transmitted from set-top box 630 through communication medium 620 to provider 610.

In one embodiment, provider 610 is to transmit a set of advertisements to settop box 630 through communication medium 620. Set-top box 630 receives the set of advertisements through communication medium 620.

In one embodiment, the functionality of set-top box 630 described above may be incorporated into television 640. Set-top box 630 may be absent from the system and television 640 may be connected to or otherwise in direct communication with communication medium 620.

In one embodiment, the second set of categories of content of broadcasted programs includes a fixed, immutable subset of categories.

The classification of a broadcasted program into a category of content may be based on an analysis of data available from an electronic programming guide. This analysis could be based upon the title of the broadcasted program, or on a description of the broadcasted program. In one embodiment, the first set of categories of content of broadcasted programs is determined by a media provider. In one embodiment, a different first set of categories of content of broadcasted programs may be generated especially for different types of viewers. For example, one set of categories could be generated for sports fans. Another set of categories could be generated for people who like to watch news.

The embodiments described above can be implemented using software in a TV viewing system. Such a TV viewing system can be implemented in many ways. A typical approach to implementation uses a set-top box that contains, among other things, a CPU, storage (e.g., RAM, ROM, etc.), a receiving network adapter, and circuitry to drive a viewing system such as a TV, monitor, projector, etc. All of these elements are not necessarily shown, but are well know in the art. For purposes of the embodiments described below, any other grouping, such as a TV with a built-in CPU, or a personal computer with TV capabilities are considered to be equivalent. Such television viewing system are typically supplied with TV content by system operators, including but not limited to cable provider/operators, satellite provider/operators, broadcasters, overbuilders, etc.

The method and apparatus disclosed herein may be integrated into advanced Internet-or network-based knowledge systems as related to information retrieval, information extraction, and question and answer systems. The system has a processor coupled to a bus. Also coupled to the bus are a memory which may contain instructions. Additional components coupled to the bus are a storage device (such as a hard drive, floppy drive, CD-ROM, DVD-ROM, etc.), an input device (such as a keyboard, mouse, light pen, bar code reader, scanner, microphone, joystick, etc.), and an output device (such as a printer, monitor, speakers, etc.). Of course, an exemplary computer system could have more components than these or a subset of the components listed.

The method described above can be stored in the memory of a computer system (e.g., set top box, video recorders, etc.) as a set of instructions to be executed. In addition, the instructions to perform the method described above could alternatively be stored on other forms of machine-readable media, including magnetic and optical disks. For example, the method of the present invention could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the methods as discussed above, could be implemented in additional computer and/or machine readable media, such as discrete hardware components as large-scale integrated circuits (LSI's), application-specific integrated circuits (ASIC's), firmware such as electrically erasable programmable readonly memory (EEPROM's); and electrical, optical, acoustical and other forms of propagated signals (e.g., carrier waves, infrared signals, digital signals, etc.); etc.

Although the present invention has been described with reference to specific exemplary embodiments, it will be evident that various modifications and changes may be made to these embodiments without departing from the broader spirit and scope of the invention. One skilled in the art will appreciate that the embodiments described above apply also to satellite and internet and telephone systems as well as the cable systems described. Accordingly, the specification and drawings are to be regarded in an illustrative rather than a restrictive sense.

What is claimed is:

1. A method comprising:
receiving input identifying a first broadcasted program; and
selecting content, based on the input, to be displayed in a background area of an interactive programming guide.

2. The method of claim 1, wherein the first broadcasted program is selected from a set of broadcasted programs displayed in the interactive programming guide.

3. The method of claim 1, wherein the first broadcasted program is selected by a user of the interactive programming guide.

4. The method of claim 1, wherein the content includes an image from the first broadcasted program.

5. The method of claim 1, wherein the content includes information about a subject associated with the first broadcasted program.

6. The method of claim 1, wherein the content is selected based on a category of the first broadcasted program.

7. The method of claim 6, wherein the content includes information about a subject associated with the category.

8. A machine-readable medium that provides instructions that, when executed by a machine, cause the machine to perform operations comprising:
receiving input identifying a first broadcasted program; and
selecting content, based on the input, to be displayed in a background area of an interactive programming guide.

9. The machine-readable medium of claim 8, wherein the first broadcasted program is selected from a set of broadcasted programs displayed in the interactive programming guide.

10. The machine-readable medium of claim 8, wherein the first broadcasted program is selected by a user of the interactive programming guide.

11. The machine-readable medium of claim 8, wherein the content includes an image from the first broadcasted program.

12. The machine-readable medium of claim 8, wherein the content includes information about a subject associated with the first broadcasted program.

13. The machine-readable medium of claim 8, wherein the content is selected based on a category of the first broadcasted program.

14. The machine-readable medium of claim 13, wherein the content includes information about a subject associated with the category.

15. A system comprising:
a first unit to receive input identifying a first broadcasted program; and
a second unit to select content, based on the input, to be displayed in a background area of an interactive programming guide.

16. The system of claim 15, wherein the first broadcasted program is selected from a set of broadcasted programs displayed in the interactive programming guide.

17. The system of claim 15, wherein the first broadcasted program is selected by a user of the interactive programming guide.

18. The system of claim 15, wherein the content includes an image from the first broadcasted program.

19. The system of claim 15, wherein the content includes information about a subject associated with the first broadcasted program.

20. The system of claim 15, wherein the content is selected based on a category of the first broadcasted program.
